(19) United States
(12) Patent Application Publication
(10) Pub. No.: US 2004/0028069 A1
(43) Pub. Date: Feb. 12, 2004

(54) Event bus with passive queuing and active routing

(76) Inventors: Glen D. Tindal, Colorado Springs, CO (US); Jeffery A. Schenk, Cambria, CA (US)

Correspondence Address: COOLEY GODWARD LLP, ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 10/213,950

(22) Filed: Aug. 7, 2002

(51) Int. Cl. H04L 12/54; H04L 12/28

(52) U.S. Cl. 370/429; 370/400

(57) ABSTRACT

An event bus for managing network event messages is described. In one embodiment, the event bus includes an interface for receiving an event message; a routing manager configured to determining whether an event message received at the interface should be routed to a destination device or whether it should be queued for retrieval by the destination device; a queue for storing the event message; and a network event storage device configured to store a copy of the event message.

### RELATED APPLICATIONS

The following commonly owned and assigned patent applications are hereby incorporated by reference in their entirety:

patent application Ser. No. 09/730,864, Attorney Docket No. CNTW-001/00US, entitled System and Method for Configuration, Management and Monitoring of Network Resources, filed on Dec. 6, 2000;

patent application Ser. No. 09/730,680, Attorney Docket No. CNTW-002/00US, entitled System and Method for Redirecting Data Generated by Network Devices, filed on Dec. 6, 2000;

patent application Ser. No. 09/730,863, Attorney Docket No. CNTW-003/00US, entitled Event Manager for Network Operating System, filed on Dec. 6, 2000;

patent application Ser. No. 09/730,671, Attorney Docket No. CNTW-004/00US, entitled Dynamic Configuration of Network Devices to Enable Data Transfers, filed on Dec. 6, 2000;

patent application Ser. No. 09/730,682, Attorney Docket No. CNTW-006/00US, entitled Network Operating System Data Directory, filed on Dec. 6, 2000.

patent application Ser. No. 09/799,579, Attorney Docket No. CNTW-006/01US, entitled Global GUI Interface for Network OS, filed on Jul. 2, 2001;

patent application Ser. No. 09/942,834, Attorney Docket No. CNTW-007/00US, entitled System and Method for Generating a Configuration Schema, filed on Aug. 29, 2001;

patent application Ser. No. 09/942,833, Attorney Docket No. CNTW-008/00US, entitled System and Method for Modeling a Network Device's Configuration, filed on Aug. 29, 2001; and

patent application Ser. No. 09/991,764, Attorney Docket No. CNTW-011/00US, entitled System and Method for Generating a Representation of a Configuration Schema, filed on Nov. 26, 2001.

### FIELD OF THE INVENTION

The present invention relates generally to network systems. More particularly, but not by way of limitation, the present invention relates to systems and methods for configuration, management and monitoring of network resources such as routers, optical devices and the like.

### BACKGROUND OF THE INVENTION

With the ever-increasing reliance upon electronic data, businesses are becoming more and more reliant upon those networks responsible for distributing that data. Unfortunately, the rapid growth in the amount of data consumed by businesses has outpaced the development and growth of certain necessary network infrastructure components. One reason that the development and growth of the network infrastructure has lagged behind centers on the present difficulty in expanding, configuring, and reconfiguring existing networks. Even the most routine network expansions and reconfigurations, for example, require significant, highly technical, manual intervention by trained network administrators. Unfortunately, these highly trained network administrators are in extremely short supply. Thus, many needed network expansions and reconfigurations are delayed or even completely avoided because of the inability to find the needed administrators to perform the required laborious, technical tasks.

The present difficulty in configuring and reconfiguring networks is best illustrated by an example directed toward installing a single new router on an existing network. To install a new router (such as router 100 or 105 in FIG. 1), an administrator 110 first would need to choose a particular router with the best attributes for the network. The basic configuration of the new router generally will be defined by its manufacturer and its model. Although it would seem that the router should be chosen based upon its attributes, administrators 110 often choose a router based upon the identity of its manufacturer and the administrator's ability to configure devices from that manufacturer. Administrators 110, for example, may only know how to configure and operate devices manufactured by Cisco Systems, Inc. and may overlook equal or even superior devices from other manufacturers merely because they cannot configure them.

After the administrator 110 has chosen the desired router (router 105, for example), the administrator 110 generally will order the router 105 from the manufacturer and have it shipped, not necessarily to the installation site, but rather to the administrator's site where a basic configuration can be installed. The administrator 110 then ships the router 105 to the installation site where it can be physically installed. After the router 105 has been physically installed, the administrator 110 typically is manually notified, e.g., by telephone, that the router 105 is connected to the network. The administrator must then create the device-specific commands required to fully configure the router 105 and transfer those commands to the router's memory 115. After the administrator 110 verifies that the device-specific commands were installed correctly, the router 105 can be brought online.

Obviously, the steps required for an administrator to configure a single router are quite cumbersome and require significant technical skill. The problem, however, is even more severe when the administrator desires to simultaneously configure or reconfigure several network devices. First, the administrator, for example, would need to manually identify the network devices that need to be configured or reconfigured. For example, if the administrator desired to turn up service between two points, the administrator would need to identify the routers along the path between the two points. The administrator would then need to verify that the policies and rules established for the network permit the contemplated reconfiguration for those devices. Assuming that the reconfiguration is within the network's policies and rules, the administrator would need to create the device-specific code required to reconfigure each of the identified devices. In many instances, the same device-specific code cannot be used on all of the devices. For example, the device-specific commands required to reconfigure a Cisco™ router differ significantly from the device-specific commands required to reconfigure a Juniper™ router. Thus, if the identified network devices include both Cisco™ and Juniper™ routers, the administrator would be required to create different versions of the device-specific commands, thereby significantly increasing the chance for error in the reconfiguration process.

Once the device-specific commands have been created for each of the identified network devices, the commands must be manually transmitted to each device. That is, a connection, e.g., a telnet connection, must be established to each device and the particular commands transferred thereto. After each device has received its commands, the network administrator must manually reconnect to each device and verify that the device received the proper commands and that it is operating properly.

Although some tools have been developed to help administrators perform certain ones of the laborious tasks of network management, these tools are extremely limited in their application. For example, CiscoWorks™ is a group of unrelated tools that can aid administrators in some enterprise level tasks. CiscoWorks™ and similar tools provide singularly focused, unrelated tools to perform activities such as quality of service (QOS) provisioning and network policy management. These tools do not provide a way to interrelate the various happenings in a network. In essence, these present network tools lack a holistic approach to network administration.

Moreover, tools like CiscoWorks™ are generally dedicated to the management of one type of network device, e.g., router or optical device, and one brand of network device. For example, CiscoWorks™ does not help an administrator configure a Juniper™ router, and it does not help an administrator configure optical devices. Thus, if the network has both Cisco™ and Juniper™ devices, multiple, unrelated tools must be utilized to perform basic network management tasks. Unfortunately, because these multiple unrelated tools are so difficult to manage, network administrators are prone to select routers based upon manufacturer identity rather than upon device features.

In addition to several other drawbacks, these singularly focused network tools result in substandard fault detection and recovery. For example, in present systems, once a configuration is changed, there is no easy way to “back out” of that configuration if a problem arises. Presently, if a new configuration for a target device fails, the network administrator would be forced to recreate the device-specific commands of the target device's previous configuration, manually connect to the device and then transmit the recreated device-specific commands to the device. As can be appreciated, this process can be extremely time consuming and error prone.

The lack of a comprehensive, holistic tool to manage network resources has led to slowed expansion and the underutilization of existing networks. As skilled administrators become more scarce and as networks grow larger and more complicated, the problems surrounding network management could reach crisis proportions. Accordingly, an integrated network administration tool is needed. In particular, a system and method are needed to efficiently configure, monitor and manage network devices without regard for device type and/or manufacturer.

### SUMMARY OF THE INVENTION

In one innovative aspect, a system and method for the configuration and monitoring of network devices has been developed. In one embodiment, the present invention provides a system and method to configure, monitor and/or manage network devices without regard to device type and/or manufacturer identity. One implementation of this embodiment includes a network manager unit disposed between the network administrator and the network devices. The network manager unit allows the administrator to holistically view, configure and manage an entire network. That is, the administrator can view, configure and manage, for example, both optical devices and/or routers without regard to manufacturer identity or specific model. The administrator can implement this holistic approach with the use of a central repository for all configuration information and/or a central posting location for all network events.

In one embodiment, for example, an administrator can configure a new device or reconfigure an existing device by logging into the network manager unit and selecting a particular network device to configure. The network manager unit can then retrieve a configuration record unique to the selected network device from the common repository and provide that record to the administrator. After receiving the record, the administrator can change fields therein without regard for manufacturer identity of the network device. Next, the network manager unit can automatically verify that the requested changes to the configuration record comply with the policies and rules established for the network, and assuming that the changes do not violate any of the policies or rules, the network manager unit can update and store the modified configuration record in the central repository. A copy of the old configuration record can be kept in the central repository for fault recovery, modeling and other purposes.

Once the configuration record has been changed, network manager unit can use the fields of the modified configuration record to generate the actual device-specific commands needed to configure the selected network device. For example, the fields in the configuration record can be used to populate variable fields in a device-specific code template. In such an embodiment, the administrator is not required to know or create the actual device-specific commands that are required to configure the selected network device. Instead, the administrator only needs to know the general objective such as “enable router.” The network manager unit will transform this general objective into the actual device-specific commands.

After the network manager unit has created the device-specific commands to match the altered configuration record, these commands are automatically pushed to the selected network device and stored in memory therein. A copy of those commands is also stored in association with the configuration record. Finally, after the new device-specific commands have been pushed to the selected network device, the network manager unit can verify the proper installation and operation of the new configuration information.

In essence, one embodiment of the present invention allows a configuration record to be created and/or modified for each network device regardless of the device's type, manufacturer or model. Each of the configuration records can be stored in a central repository for simplified access, retrieval and editing. Thus, to change the configuration for any network device, the network manager unit need only retrieve the altered configuration record from the central repository, generate the device-specific commands based upon that configuration record and push those generated device-specific commands to the target network device.

In another innovative aspect, the present invention enables automatic responses to network events. For example, network devices can be configured to post messages to a central posting location at the network manager unit. The network manager unit can read these posted network events from the central posting location and determine a proper response based upon predefined rules and policies. The network manager unit can then automatically implement the response. For example, if a particular router becomes congested, that router can post a message to the central posting location. The network manager unit can then read that message and determine the appropriate response for the congested router. The policy could indicate, for example, that the router configuration should be changed to enable congestion handling features. The network manager unit, in this scenario, could automatically reconfigure the router to enable those congestion-handling features.

In addition to exchanging messages with network devices, the present invention can also exchange messages with an operation support system (OSS) or as it is often called, a back office system. In one embodiment, the network manager unit includes an enterprise application interface (EAI), such as a CORBA interface, for communicating with the OSS. Using this EAI, the network manager can notify the OSS of network events and can receive messages from the OSS, some of which may impact the configuration of various network devices. For example, if a customer requests a Ti line between point A and point B for three days, the network manager unit can generate an appropriate message to send to the billing OSS once the Ti line has been provisioned.

As can be appreciated by those skilled in the art, the present invention addresses the significant shortfalls in present network technology as well as providing new and innovative features. In particular, the present invention provides a holistic way to configure, manage and view an entire network system. These and other advantages of the present invention are described more fully herein.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 illustrates a present system for configuring network routers;

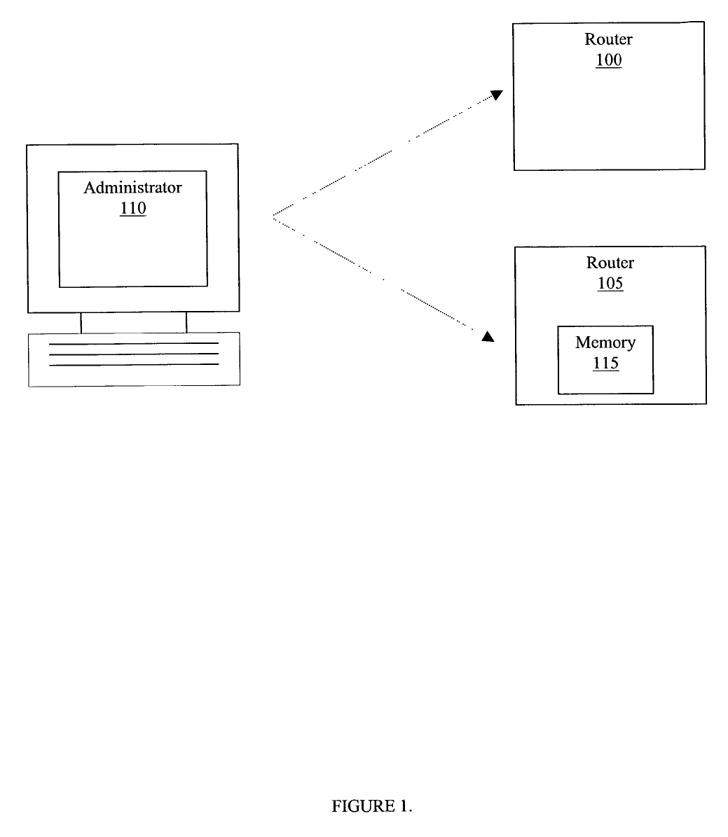

FIG. 2 illustrates a system for configuring network devices in accordance with the principles of the present invention;

FIG. 3 illustrates in more detail the network manager unit shown in FIG. 2;

FIG. 4 illustrates in more detail the directory element shown in FIG. 3;

FIG. 5 illustrates a configuration record for a typical network device in accordance with the present invention;

FIG. 6A illustrates in more detail the event bus shown in FIG. 3;

FIG. 6B illustrates an alternate embodiment of the event bus shown in FIG. 3; and

FIG. 7 is a flow chart of a method for configuring a network device in accordance with the present invention.

### DETAILED DESCRIPTION

Although the present invention is open to various modifications and alternative constructions, a preferred exemplary embodiment that is shown in the drawings is described herein in detail. It is to be understood, however, that there is no intention to limit the invention to the particular forms disclosed. One skilled in the art can recognize that there are numerous modifications, equivalents and alternative constructions that fall within the spirit and scope of the invention as expressed in the claims.

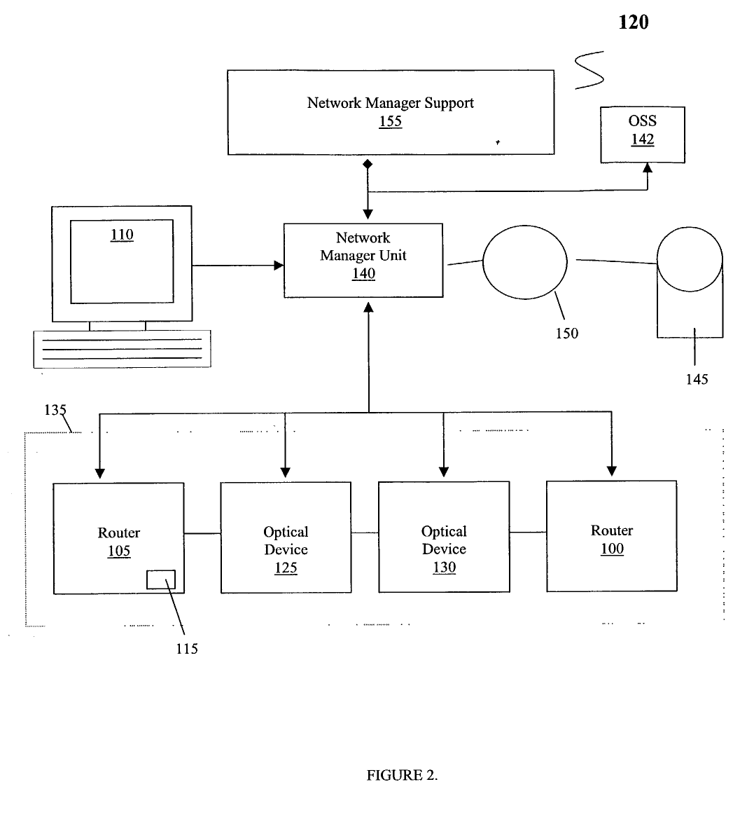

Referring now to FIG. 2, there is illustrated a system 120 for configuring network devices 100, 105, 125, 130 (collectively 135) in accordance with the principles of the present invention. This embodiment includes a network manager unit 140 disposed between the administrator 110 and the network devices 135, which can include routers, optical devices, etc. The network manager unit 140 is also disposed between the network device 135 and the OSS 142. Additionally, the network manager unit 140 is connected to remote storage 145 (connected by network 150) and a network manager support 155.

To alter the configuration of a network device 135 or to add a network device to an existing network, the administrator 110 can access the network manager unit 140, search for and retrieve the configuration record corresponding to a target network device, and through a series of interactive, wizard-like screens, change the configuration record for the target network device. This altered configuration record is stored in a central repository in the network manager unit 140 and can be checked against network policies accessible by the network manager unit 140. Next, the network manager unit 140 can generate device-specific commands from the new configuration record and push those device-specific commands to the target network device or have the target network device pull the commands. Finally, the network manager unit 140 can verify that the new configuration was installed correctly at the target network device.

To generate the necessary device-specific commands, the network manager unit 140 may access the remote storage device 145 that can contain the various templates needed to generate device-specific commands for different types, brands and/or models of network devices. Each of these templates can contain variable fields corresponding to either information stored in the configuration records or information input directly by the administrator. The network manager unit 140 generates the device-specific commands by retrieving the appropriate template and filling in the variable fields with the data from the configuration records and/or data input directly by the administrator 110. Once generated, these device-specific commands can be stored in the configuration record and/or they can be stored in the remote storage device 145 with an appropriate pointer stored in the configuration record.

In addition to configuring and reconfiguring network devices, the network manager unit 140 can communicate with the OSS 142. In particular, the network manager unit 140 can receive data from the OSS 142, which in one embodiment can be used in generating the device-specific commands for a network device. Furthermore, the network manager unit 140 can provide the OSS 142 with messages relating to network events. For example, if the network manager unit 140 receives a request from a customer to move five terabytes of data from point A to point B, the network manager unit 140 can configure the network devices 135 to enable that transfer and can notify the billing OSS 142 of the transaction. The billing OSS 142 can then generate the necessary charges for that customer.

OSS's generally use a standard enterprise application interface (EAI) called CORBA. Other standard and non-standard interfaces, however, do exist. To communicate with these standard and non-standard interfaces, the network manager unit 140 can include a corresponding interface. For example, if the OSS 142 includes a CORBA interface, the network manager unit 140 can also include a CORBA interface or at least some portion of a CORBA interface.

Because CORBA, and interfaces like it, were designed as all inclusive interfaces, they are often cumbersome and processor intensive. To make communication between an OSS's interface and the network manager unit 140 more efficient, the present invention can include a wide area network transport mechanism that facilitates a lightweight distributed object (LDO) capability.

As can be appreciated by those skilled in the art, the network manager unit 140 can be implemented on virtually any hardware system. Good results, however, have been achieved using components running the Red Hat™ LINUX Operating System and the Sun Solaris™ UNIX Operating System. In embodiments running either of these operating systems, the network manager unit 140 is configured to utilize the common services provided by that particular operating system.

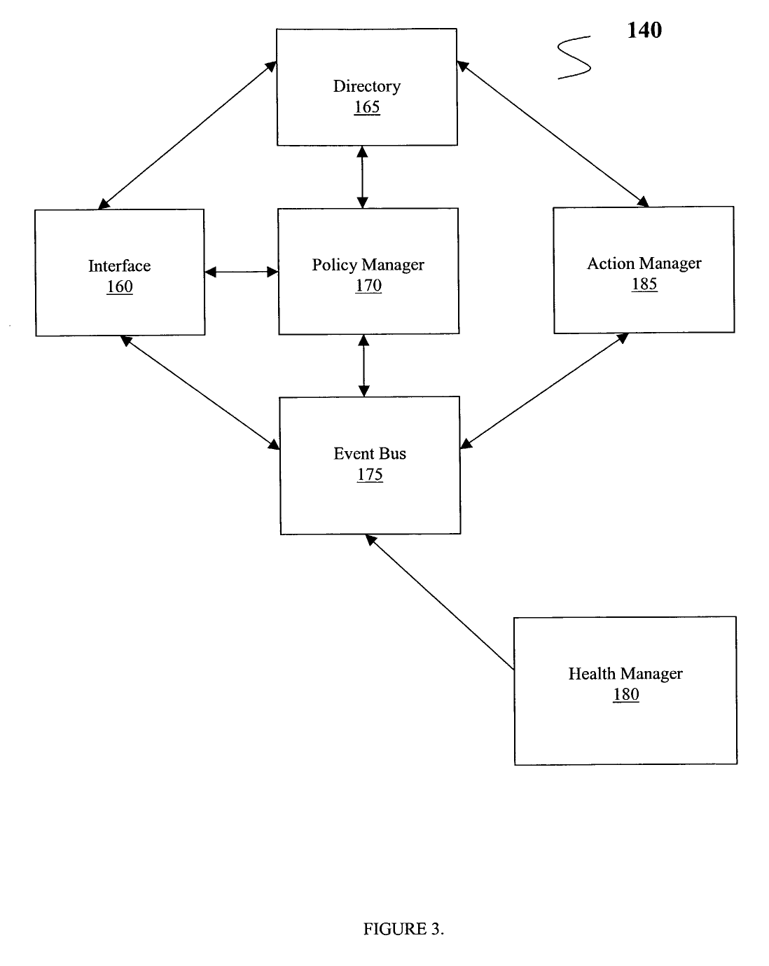

Referring now to FIG. 3, there is illustrated in more detail the network manager unit 140 shown in FIG. 2. This embodiment of the network manager unit 140 includes six basic modules: an interface 160, a directory 165, a policy manager 170, an event bus 175, a health manager 180 and an action manager 185. The illustrated connections between the various components are exemplary only. The components can be connected in a variety of ways without changing the basic operation of the system. Although the division of the network manager unit 140 into the six components is the presently preferred embodiment, the functions of these components could be subdivided, grouped together, deleted and/or supplemented so that more or less components can be utilized in any particular implementation. Thus, the network manager unit 140 can be embodied in several forms other than the one illustrated in FIG. 3.

Referring first to the interface module 160, it is designed to exchange data with the administrator 110 (shown in FIG. 2) and, in some embodiments, with the network devices 135 (also shown in FIG. 2). Although the interface 160 could implement virtually any type of interface, good results have been achieved using a graphical, web interface. Other interfaces can be based upon wireless protocols such as WAP (wireless application protocol).

The second component of the network manager unit 140 is the event bus 175. The event bus 175 includes a central posting location for receiving messages relating to network events. For example, when a configuration for a network device 135 is to be changed, an appropriate message can be published (or otherwise made available) to the event bus 175. Similarly, if a network condition such as an error occurs, an appropriate message can be published to the event bus 175. Notably, any message published to the event bus 175 can also be sent to the administrator 110 by way of the interface 160. The administrator 110, however, does not necessarily need to respond to a received message for the event to be addressed by the network manager unit 140.

To determine the proper response for a message posted to the event bus 175, the received message can be compared against the policies stored in the policy manager 170, which is a repository for the business and network policies and rules used to manage the network. By using these rules and policies, an administrator 110 (shown in FIG. 2) can define a response for any event published to the event bus 175. The defined response can be virtually anything including reconfiguring a network device, shutting down a network device and notifying an administrator.

In operation, the policy manager 170 can read a message posted to the event bus 175. Alternatively, the event bus 175 can automatically push the message to the policy manager 170. Either way, however, the policy manager 170 uses the message to access the policy records that can be stored, for example, in a look-up table and to correlate the message to the appropriate response. Once the policy manager 170 has determined the appropriate response, that response is published to the event bus 175 as a work order that can be read by the action manager 185 and subsequently executed. That is, the action manager 185 can read the work order from the event bus 175 and perform the necessary tasks to complete that work order. In other embodiments, the work order can be sent directly to the action manager 185. For example, assume that the action manager 185 reads a work order from the event bus 175 that indicates two routers—one a Cisco™ router and one a Juniper™ router—need to be enabled. The action manager 185 can locate each of these routers and determine the device-specific code needed to enable them. The code required to enable the Cisco™ router, for example, might be “enable_router” and the code required to enable the Juniper™ router might be “router_enable.” Because the action manager 185 determines the appropriate device-specific code, however, the administrator 110 (shown in FIG. 2) only needs to generically indicate that both devices are to be enabled. The administrator 110 does not need to know the actual device-specific code required by each router.

In other embodiments, the action manager 185 can verify that the administrator 110 (shown in FIG. 2) has authority to make changes to network devices without authorization from additional parties. If additional authorization is required, the action manager 185 can post an appropriate message to the event bus 175.

Still referring to FIG. 3, the directory 165 of the network manager unit 140 includes a central repository for storing the configuration records of each of the network devices connected to the network manager unit 140. For example, the directory 165 could store a separate configuration record for each of network devices 100, 105, 125 and 130 shown in FIG. 2. In certain embodiments, several interconnected directories may be utilized, and in such systems, each directory can store a certain subset of the configuration records or a complete copy of all of the configuration records. Generally, such embodiments would employ multiple linked network manager units 140, and in the embodiment where complete copies of the configuration records are stored in different directories, synchronization techniques can be used to guarantee data integrity.

The configuration records stored in the directory 165 are searchable by way of the interface 160. That is, the administrator 110 or a component within the network manager 140 (shown in FIG. 2) can initiate a search through the interface 160 and the results of that search can be made available to the administrator 110 through the interface 160. Moreover, the configuration records can be searched in any of a variety of ways. For example, the configuration records can be searched according to equipment type (e.g., routers, optical devices, etc.), device type (edge router, core router, etc.), device location, device manufacturer, device model, device name, operational status, etc. The directory 165 can be used to enable directory-based networking.

Referring now to the health manager 180, it can be configured to monitor the overall health of the network and/or the health of individual network devices 135 (shown in FIG. 2) within the network. The health manager 180 can operate in an active mode and/or a passive mode. In the active mode, the health manager actively polls at least some of the network devices 135 about their status, utilization, congestion, etc. In the passive mode, the various network devices 135 automatically report to the health manager 180. In either embodiment, however, the health manager 180 can collect individual device information and model overall network health. Additionally, the health manager 180 can publish messages regarding network device problems, projected network device problems, network problems, and/or projected network problems. The policy manager 170 can then determine the appropriate course of action to take for the particular message and the action manager 185 can implement that response.

In further embodiments, the health manager can monitor the health of the network manager components. For example, the health manager can monitor the operation of the event bus, the action manager and/or the directory. Moreover, the health manager can monitor the flow of data between the various components of the network manager.

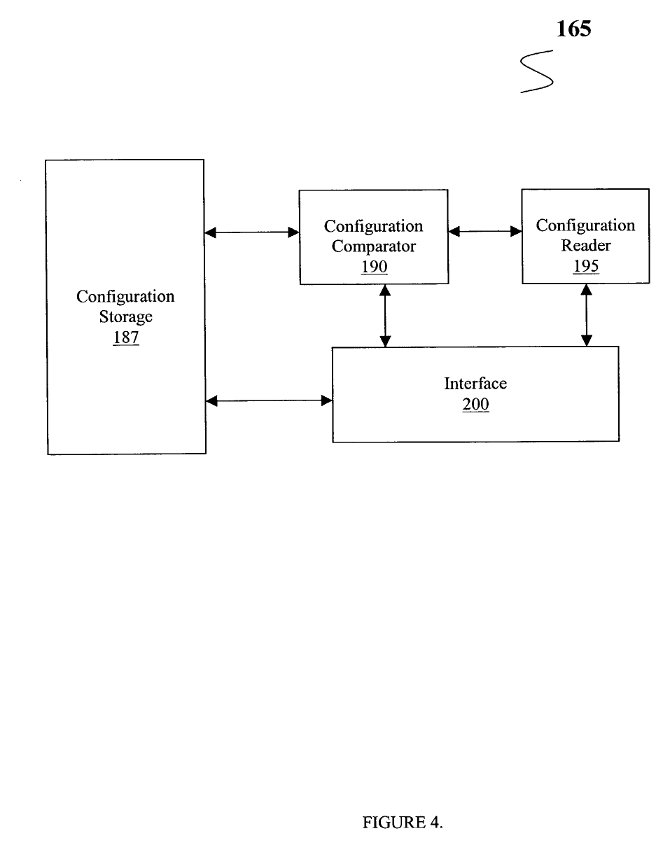

Referring now to FIG. 4, there is illustrated in more detail the directory 165 shown in FIG. 3. This embodiment of the directory 165 consists of four interconnected modules: configuration storage 187, configuration comparator 190, configuration reader 195 and interface 200. The directory 165, however, does not need all of the modules to function in accordance with the principles of the present invention.

The configuration reader module 195 of the directory 165 is designed to initiate communication with (or directly communicate with) a target network device and retrieve that device's actual configuration. For example, the configuration reader can retrieve the actual configuration from the memory 115 of router 105 (shown in FIG. 2). This retrieved actual configuration can then be passed to the configuration comparator 190. The configuration reader 195 can also retrieve the intended configuration of the target device from the configuration storage 187 and pass that intended configuration to the configuration comparator 190. The configuration comparator 190 can then compare the actual configuration and the intended configuration and present the differences to the administrator 110 (shown in FIG. 2). In one embodiment, the differences in the configurations are not only presented literally, but also in a natural language summary form. Once the differences have been identified, they can be used to identify a failed configuration installation and/or to aid the administrator in creating the proper configuration for a device.

As previously discussed, the configuration storage 187 is designed to store configuration records corresponding to network devices such as network devices 135 shown in FIG. 2. In one embodiment the configuration storage 187 is designed not only to store the present configuration record for a network device, but also to store previous configuration records for that device. By storing these previous configurations, fault recovery and correction are vastly improved over present systems because prior, successful configurations can be quickly retrieved and used to replace new, faulty configurations. For example, a prior configuration of a previously known good state can be retrieved and installed on the associated network device. This prior configuration could be days old or even weeks old. Prior configuration records can be distinguished by version numbers and/or a time stamp. Additionally, each configuration record can include a searchable summary that includes notes on the configuration and why that configuration was modified.

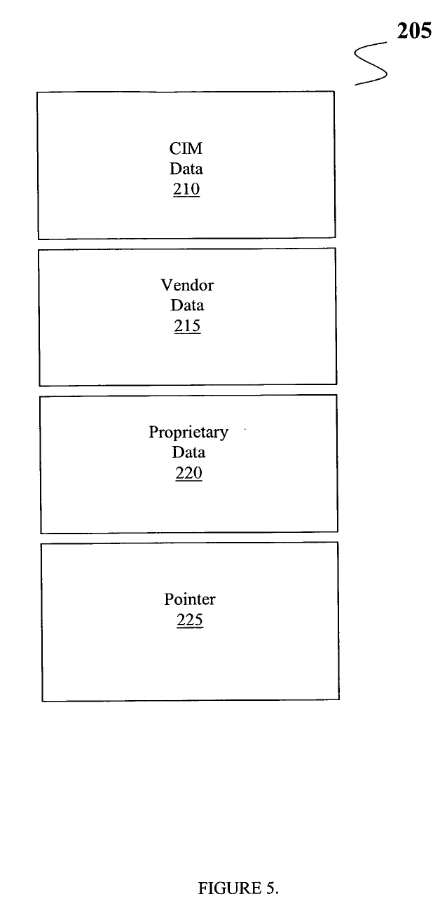

Referring now to FIG. 5, there is illustrated a configuration record 205 for a typical network device. This configuration record 205 is divided into four portions: a common information model (“CIM”) data portion 210, a vendor data portion 215, proprietary data portion 220 and a data pointer 225. The CIM data portion 210 contains data relating to the physical attributes of a particular network device such as name, device type, number of interfaces, capacity, etc. The CIM data items are defined in the CIM Specification v2.2 and the CIM Schema v2.4, both of which are well known in the art and incorporated herein by reference.

The vendor data portion 215 of the configuration record contains standard vendor-specific data regarding the particular network device. For example, the vendor data portion 215 could indicate which version of an operating system that the network device is running or which features of the device are enabled. Generally, the data in the vendor data portion 215 is specific to each manufacturer and even to each model of network device.

The proprietary data portion 220 of the configuration record can contain data used by the network manager unit in configuring and managing the network devices. In one embodiment, for example, the proprietary data portion 220 includes a pointer to an address at which a core dump for a network device is stored. That is, if a router initiates a core dump, the location of that core dump could be recorded in the proprietary data portion 220 of the configuration record for that router. In other embodiments, the proprietary data portion 220 can store version numbers, time stamps, health records for a particular configuration, configuration summary data, configuration notes, etc.

The pointer portion 225 of the configuration record 205 can be used to point to a storage location where the actual device-specific commands for the associated network device are stored. Similarly, the pointer 225 could be configured to point to a storage location for a device-specific template for configuring a newly installed network device. In other embodiments, the pointer portion 225 of the configuration record can be supplemented or replaced with a storage location for actual device-specific code.

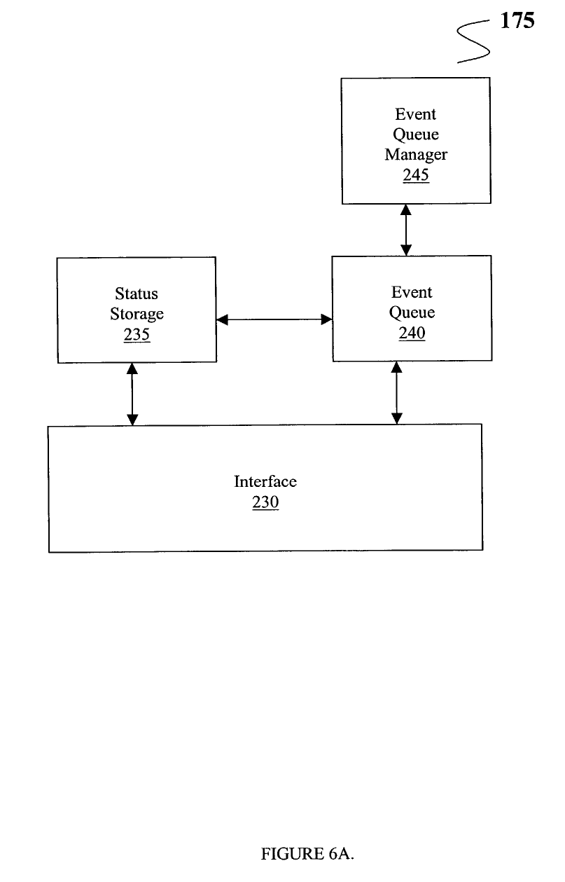

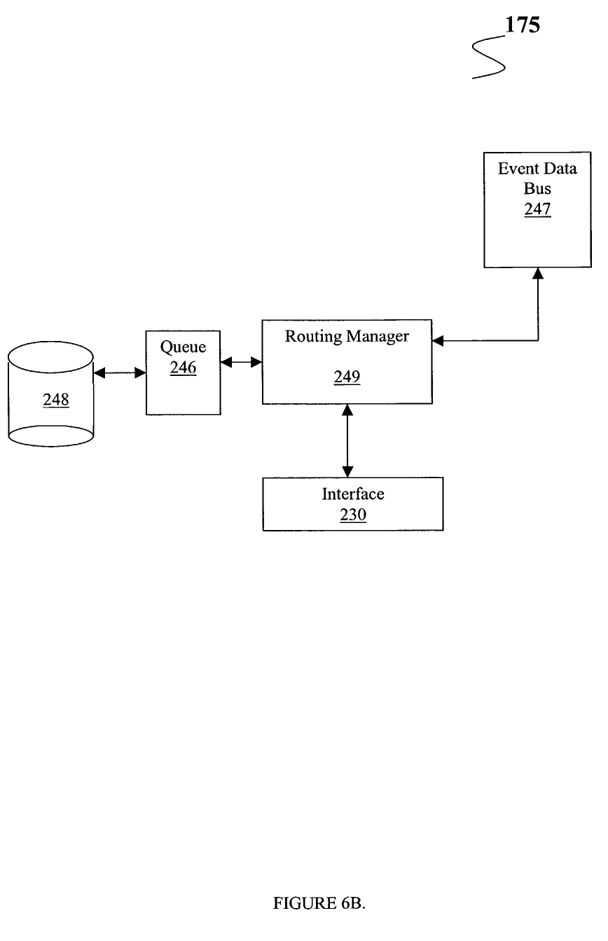

Referring now to FIG. 6A, there is illustrated in more detail the event bus 175 shown in FIG. 3. As previously described, the event bus 175 is a posting location for messages relating to network events. Network devices as well as the other components of the network manager unit 140 (shown in FIG. 2) can address and post events to the event bus 175.

The particular embodiment of the event bus 175 shown in FIG. 6A is comprised of four basic modules: an interface 230, a status storage 235, an event queue 240, and an event queue manager 245. In operation, a message indicating the occurrence of a network event is posted to the event queue 240 by way of the interface 230. The messages stored at the event queue 240 are then made available to the policy manager 170 (shown in FIG. 3), so that a proper response can be determined. If the posted message is a work order from the policy manager 170, the work order is made available to the action manager 185 (shown in FIG. 3) for subsequent implementation.

In one embodiment of the event bus 175, an event message is stored in status storage 235 along with a status field and an age field. Thus, for any message posted to the event bus 175, its status and age can be continuously monitored. (The event bus 175 can also get messages from client devices.) For example, status storage 235 could indicate that the status for a particular event is pending in the action manager 185 (shown in FIG. 3), awaiting proper authorization, completed, stalled, etc. As the status changes from one status to another, appropriate messages can be generated and posted at the event queue 240. For example, if the status of an event changes from pending to stalled, an appropriate message can be posted to the event queue 240 so that the policy manager 170 can determine how to respond. Similarly, if the age field in the status storage 235 indicates that a particular network event has not been addressed within a predetermined amount of time, that event can be requeued, deleted from the event queue 240, or a new event notification indicating the delay can be generated and placed on the event queue 240.

Referring now to FIG. 6B, there is illustrated an alternate embodiment of the event bus 175 shown in FIG. 3. Network devices, OSS's, and/or components of the network manager unit 140 (shown in FIG. 2) can address and post events to the event bus 175 by way of the interface 230. Notably, the interface 230 can include modules for receiving and transmitting different types of data formats, e.g., CORBA. In the presently preferred embodiment, communications are received from the network devices 135 in an XML format. These communications, for example, can be in the form of frames with an HTTP header and an XML payload. Alternatively, these communications can be achieved through a TCP session.

Event messages received at the interface 230 can be handled, for example, in at least one of two ways. First, the event message can be actively routed to the appropriate network device, and second, the event message can be queued and the appropriate device(s) can retrieve the event message from the queue 246. Active routing, for example, can be used for non-persistent events destined for only a few network devices or OSS's. Because a copy of the event message is not generally stored in the queue 246 during active routing, a copy can be written to the event database 247, which can store entries for each event message posted to the event bus 175 or only for certain entries posted to the event bus 175. Thus, if the actively routed event message is not received by the destination device, i.e., the device to which the event message is being routed, the event message can be retrieved and sent again. Alternately, if the actively routed event message is not responded to in an appropriate fashion, the entries in the event database 247 can indicate that fact. For example, if an event message is actively routed to a network device and the network device acknowledges receipt of that event message but reboots before that event message can be acted upon, entries in the event database 247 can so indicate. Otherwise, there would be no record of the event message or its receipt by the network device.

For messages that are queued, they can be stored either in the primary queue 246 or the secondary queue 248. The primary queue 246 is a high-speed memory device and is used for storing event messages that will be retrieved quickly and/or by a number of network devices or OSS's. The secondary queue 248, on the other hand, can be a slower memory device, such as a disk, that is used for storing event messages that are retrieved infrequently.

Decisions on whether an event message should be routed or whether it should be queued are made by the routing manager 249. The routing manager 249 can extract a type indicator from a received event message and determine, based upon that type indicator, how to handle the event message. Additionally, the routing manager can also be responsible for routing event messages to the appropriate destinations and for handling requests from network devices and OSS's. For example, the routing manager 249 can locate a queued event message and provide that event message to a requesting network device.

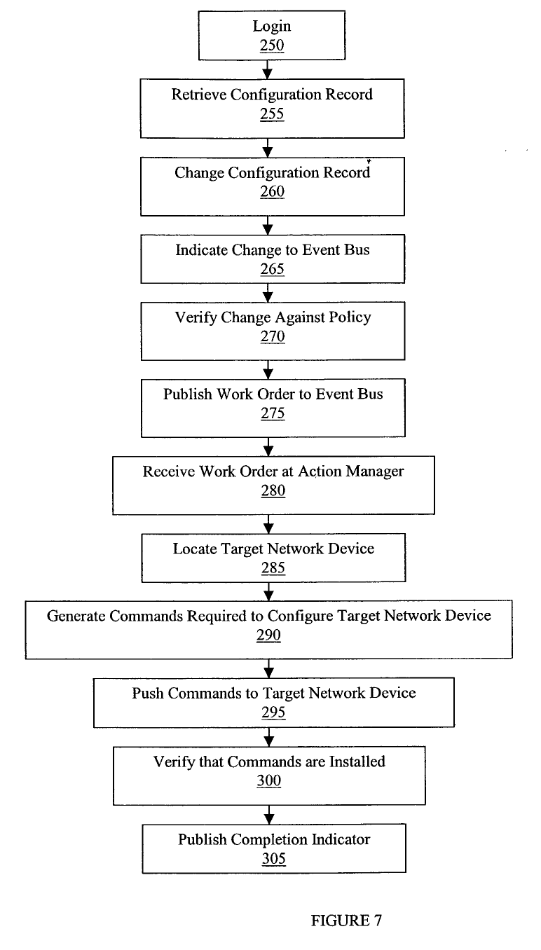

Referring now to FIG. 7, there is a flow chart of one method for configuring or reconfiguring a network device in accordance with the principles of the present invention. In this embodiment, the administrator 110 (shown in FIG. 2) initially logs into the network manager unit 140 (Step 250). Through a series of graphical interfaces, the administrator 110 can select a network device that needs to be configured or reconfigured. The configuration record associated with the selected device can then be retrieved from the directory 165 (shown in FIG. 3) and presented to the administrator (Step 255). If no configuration record is available for a selected device, the administrator 110 will be guided through a series of steps to build the configuration for that device. Otherwise, the administrator 110 can change parameters within the configuration record of the selected device and save those altered configuration records within the directory 165 (Step 260). Notably, even though the configuration record for the selected network device has been changed, the actual configuration of the device has not been changed. Before the configuration of the device can be changed, an event message indicating that a configuration record has been altered should be published to the event bus 175 (shown in FIG. 3) (Step 265). The policy manager 170 (shown in FIG. 3) then receives the event message, either by reading it from the event bus 175 or by receiving it from the event bus 175, and determines if the configuration change is authorized (Step 270). If the configuration change is within the network rules and the administrator 110 (shown in FIG. 2) is authorized to make the change, a work order is published to the event bus 175 (Step 280). The action manager 185 (shown in FIG. 3) can then read the work order from the event bus 175 and carry out the necessary steps to implement the work order (Step 280).

In one embodiment, the action manager 185 (shown in FIG. 3) carries out the work order by locating the target network device, retrieving the appropriate configuration record from the directory 165 (shown in FIG. 3), generating the device-specific code corresponding to the altered configuration (Step 290), and pushing the device-specific code to the target network device (Step 295). The action manager 185 can also store the device-specific code in a remote storage device, such as remote storage device 145 shown in FIG. 2, and a pointer to the remote storage device can be recorded in the configuration record. Finally, the action manager 185 can verify that the device-specific code was properly transferred to the selected network device and that the network device is behaving accordingly (Step 300). Assuming that the device-specific codes were installed correctly and that the network device is operating properly, a completion message is published to the event bus 175 (shown in FIG. 3) (Step 305).

In conclusion, the present system provides, among other things, a method and apparatus to configure, monitor and manage network devices without regard for device type and/or manufacturer. Those skilled in the art, however, can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A method for managing an event message, the method comprising the steps of:
receiving the event message at a central event messaging location;
determining whether the received event message should be routed to a destination device or whether the received event message should be queued for retrieval by the destination device;
responsive to determining that the received event message should be routed to the destination device, routing the event message to the destination device; and
responsive to determining that the received event message should be queued, queuing the received network event message.

2. The method of claim 1, wherein the step of receiving the event notification comprises the step of:
receiving an indicator of the type of the event message.

3. The method of claim 2, wherein the step of determining comprises the steps of:
determining whether the indicator indicates that the event message is of a first type or a second type;
responsive to the indicator indicating that the event message is of the first type, determining to route the event message; and
responsive to the indicator indicating that the event message is of the second type, determining to queue the event message in a queue.

4. The method of claim 1, further comprising the step of:
storing the event message in an event database.

5. The method of claim 4, further comprising the step of:
storing the event message in an event database responsive to determining that the event message should be routed to the destination device.

6. The method of claim 1, wherein the step of receiving comprises the step of:
receiving the event message at a central messaging location included with a network manager unit.

7. The method of claim 1, further comprising the step of:
retrieving a queued event message from the queue.

8. The method of claim 7, further comprising the step of:
altering the operation of the destination device according to the event message retrieved from the queue.

9. An event bus comprising:
an interface for receiving an event message;
a routing manager in communication with the interface, the interface configured to determining whether an event message received at the interface should be routed to a destination device or whether the event message should be queued for retrieval by the destination device;
a queue in communication with the interface, the queue for storing the event message responsive to the routing manager determining that the event message received at the interface should be queued; and
a network event storage device in communication with the interface, the network event storage device configured to store a copy of the event message responsive to at least the routing manager determining that the event message received at the interface should be routed to the destination device.

10. The event bus of claim 9, wherein the queue comprises:
a primary queue; and
a secondary queue.

11. The event bus of claim 9, wherein the interface comprises:
an enterprise application interface.

12. A computer system for managing an event message, the computer system comprising:
at least a first processor device;
at least a first memory device accessible by the at least a first processor device;
a plurality of instructions stored on the at least a first memory device, the plurality of instructions configured to cause the at least a first processor device to:
process a received event message;
determine whether the received event message should be routed to a destination device or whether the received event message should be queued for retrieval by the destination device;
responsive to determining that the received event message should be routed to the destination device, route the event message to the destination device; and
responsive to determining that the received event message should be queued, queue the received network event message.

13. The computer system of claim 12, wherein the plurality of instructions are configured to cause the at least a first processor to:
identify a type for the received event message, wherein the received event message can be of at least a first type and a second type.

14. The computer system of claim 13, wherein the plurality of instructions are configured to cause the at least a first processor to:
responsive to the type of the received event message being the first type, determine to route the event message; and
responsive to the type of the received event message being the second type, determine to queue the event message in a queue.

15. The computer system of claim 12, wherein the plurality of instructions are further configured to cause the at least a first processor to:
store the event message in an event database.

16. The computer system of claim 15, wherein the plurality of instructions are further configured to cause the at least a first processor to:
store the event message in an event database responsive to determining that the event message should be routed.

17. The computer system of claim 12, wherein the plurality of instructions are configured to cause the at least a first processor to:
queue the event message in a short-term queue.
